(19) United States
(12) Patent Application Publication
(10) Pub. No.: US 2018/0296866 A1
(43) Pub. Date: Oct. 18, 2018

(54) FLAME ARRESTER

(71) Applicant: EMPYREUS SOLUTIONS LLC, Anchorage, AK (US)

(72) Inventor: BRIAN RIORDAN, KENT, WA (US)

(21) Appl. No.: 15/950,093

(22) Filed: Apr. 10, 2018

Related U.S. Application Data
(60) Provisional application No. 62/485,858, filed on Apr. 14, 2017.

(51) Int. Cl. A62C 4/02

(52) U.S. Cl. CPC A62C 4/02

(57) ABSTRACT

The flame arrester has an elongated body having at least one sidewall and axially-opposed first and second ends. The at least one sidewall includes a plurality of ribs spaced apart from one another such that adjacent ones of the plurality of ribs define slots therebetween. Each rib has rounded side edges to minimize shear and turbulent flow through the slots. The slots are in open fluid communication with the hollow interior of the elongated body. The first end of the elongated body is open to allow insertion of a fuel dispensing nozzle or the like. The second end of the elongated body may be closed, or releasably covered and sealed by a valve mounted on the elongated body. Alternatively, the second end may be porous or have slots or flow passages formed therethrough.

### CROSS-REFERENCE TO RELATED APPLICATION

This application claims the benefit of U.S. Provisional Patent Application Ser. No. 62/485,858, filed Apr. 14, 2017.

### BACKGROUND

### 1. Field

The disclosure of the present patent application relates to safety devices for flammable fuels, and particularly to a flame arrester for permanent installation within a liquid fuel container, tank or the like, or in the neck or spout thereof.

### 2. Description of the Related Art

Flame arresters are well known for installation in elongate pipes that carry various flammable gases that may be subject to mixing with atmospheric oxygen and a possible ignition source. In many instances, flame arresters are required in such conditions. Generally, the ignition of the flammable substance within such a pipe results in a relatively high-pressure wave due to its confinement within the pipe. As a result, flame arresters configured for such installations generally comprise a diametric disk of porous material that is disposed completely across the interior of the pipe. The flame arrester material generally comprises a fine mesh or other porous configuration of thermally conductive material, usually metal, to quench the flame, and the fine porous passages therethrough serve to reduce the velocity of flame travel through the mesh disk. The metal structure also provides the structural strength required to withstand the relatively high-pressure front that occurs in the event of ignition within such a confined space.

However, there are many other environments in which ignition of a flammable vapor is possible, where the vapor is not confined to such relatively long pipes, tubes, and the like. Examples include, but are not limited to, portable fuel containers (e.g., gas cans) having relatively short dispensing spouts, and automotive fuel tanks having relatively short filler necks. The installation of conventional diametric metal flame arrester discs within such spouts and necks is generally inconvenient, as such devices (in a fuel tank filler neck) tend to prevent the insertion of a fuel nozzle therein, and in any case, the relatively fine porosity greatly restricts the flow of fuel therethrough. As a result, the users of such devices often remove the flame arrester from the spout or neck, thereby negating any potential safety that would otherwise be provided by such a device. Thus, a flame arrester solving the aforementioned problems is desired.

### SUMMARY

The flame arrester has an elongated body having at least one sidewall and axially-opposed first and second ends. The at least one sidewall can be formed from a plurality of ribs spaced apart from one another such that adjacent ones of the plurality of ribs define slots therebetween. Each rib has rounded side edges to minimize shear and turbulent flow through the slots. The slots are in open fluid communication with a hollow interior of the elongated body. The first end of the elongated body is open to allow insertion of a fuel dispensing nozzle or the like. The second end of the elongated body may be closed, or releasably covered and sealed by a valve mounted on the elongated body. Alternatively, the second end may be porous or have slots or flow passages formed therethrough.

As a further alternative, the flame arrester may include an elongated body having at least one sidewall defining an open interior and axially-opposed first and second ends, where the at least one sidewall is defined by a single helical rib. Circumferential segments of the helical rib are spaced apart from one another such that adjacent ones of the circumferential segments define a helical slot therebetween. The helical rib has a rounded side edge, and the helical slot is in open fluid communication with the hollow interior of the elongated body.

Additionally, the flame arrester may be provided in combination with a fuel tank, container or the like. In addition to the flame arrester, a throttling valve may be installed either on a nozzle of the fuel tank, as a cover, or alternatively may be installed within the fuel tank's nozzle.

These and other features of the present disclosure will become readily apparent upon further review of the following specification and drawings.

### BRIEF DESCRIPTION OF THE DRAWINGS

FIG. 1 is a perspective view of a flame arrester.

FIG. 2 is a top view in section of the flame arrester of FIG. 1.

FIG. 3 is a top view in section of an alternative embodiment of a flame arrester.

FIG. 4 is a top view in section of another alternative embodiment of a flame arrester.

FIG. 5 is a side view of yet another alternative embodiment of a flame arrester.

FIG. 6 is a perspective view of still another alternative embodiment of a flame arrester.

FIG. 7 is a perspective view of another alternative embodiment of a flame arrester.

FIG. 8 is a partial side view in section of an alternative fuel tank combined with the flame arrester.

FIG. 9 is a perspective view of a further alternative embodiment of the flame arrester.

FIG. 10 is a perspective view of another alternative embodiment of the flame arrester.

Similar reference characters denote corresponding features consistently throughout the attached drawings.

### DETAILED DESCRIPTION OF THE PREFERRED EMBODIMENTS

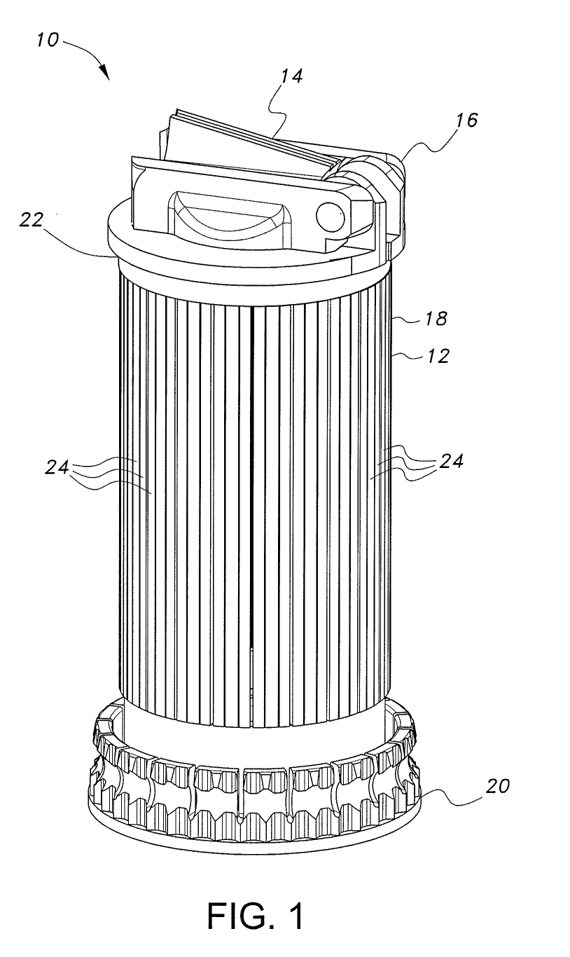

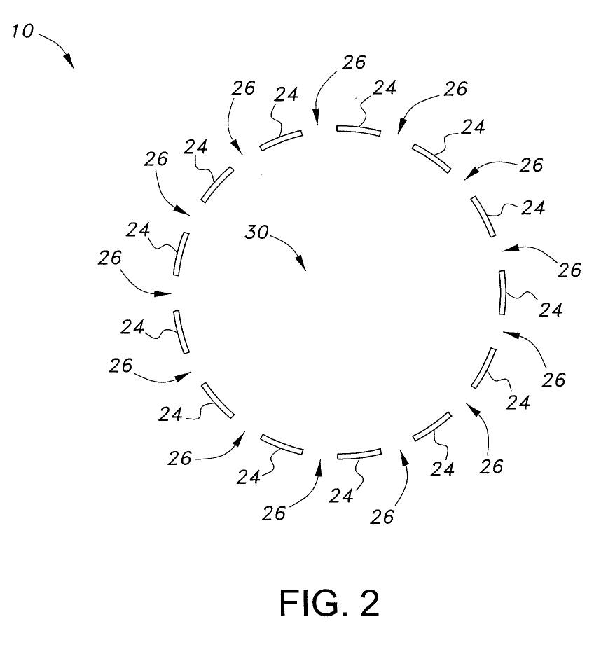

Referring to FIGS. 1 and 2, the flame arrester 10 includes an elongated body 12 having at least one sidewall 18, a first end 20 and a second end 22. As shown in FIGS. 1 and 2, the sidewall 18 is formed from a plurality of ribs 24 spaced apart from one another such that adjacent ones of the ribs 24 define slots 26 therebetween. As best seen in FIG. 2, each rib 24 has a rounded side edge in order to minimize shear and turbulent flow. The slots 26 are in open fluid communication with a hollow interior 30 of elongated body 12. The flame arrester 10 is dimensioned and configured to fit inside a gas can (or other receptacle for storing flammable materials, such as gasoline). Thus, it should be understood that the flame arrester 10 may be manufactured in a variety of different shapes and with a variety of relative dimensions, depending upon the particular gas tank or the like in which flame arrester 10 will be installed.

When used with a gas can, for example, the flame arrester 10 is installed within the can, acting as a “screen” to “filter” out a flame or a spark. Air and liquid are free to pass through the gas can's spout, but the size of the spout opening ultimately determines whether or not a flame or a spark can also pass through the spout. When gasoline vapors are ignited outside of a gas can and flash back to the source of the fuel, the flame arrester 10 prevents the flame or spark from entering the interior of the gas can, preventing explosion. It should be understood that the flame arrester 10 may not only be used with a wide variety of gas cans, tanks and the like, but may also be used with any receptacle for storing flammable materials, and may further be used with any opening or aperture associated therewith. For example, flame arrester 10 may be used in combination with the spout of a gas can, and may also be used in combination with the additional vapor vent commonly associated with conventional gas cans.

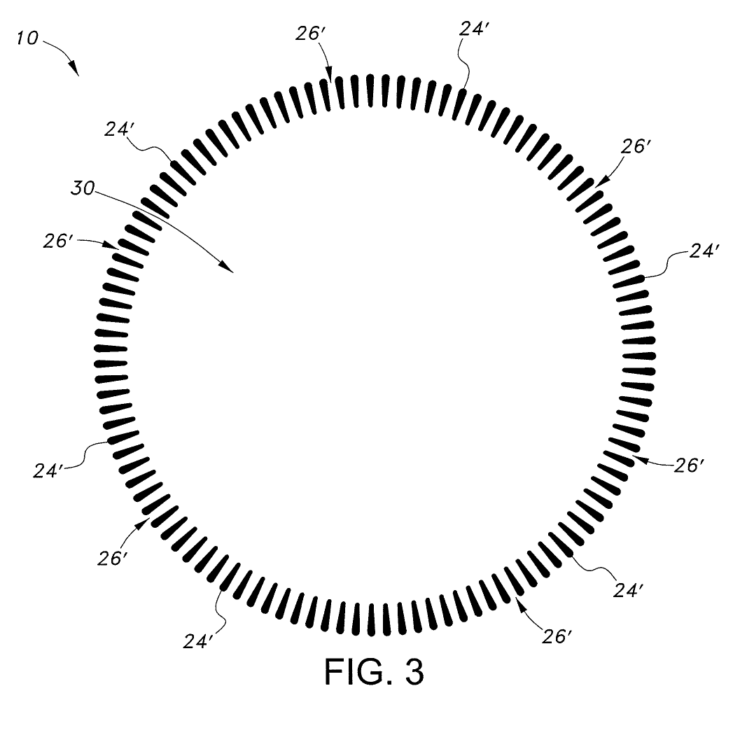

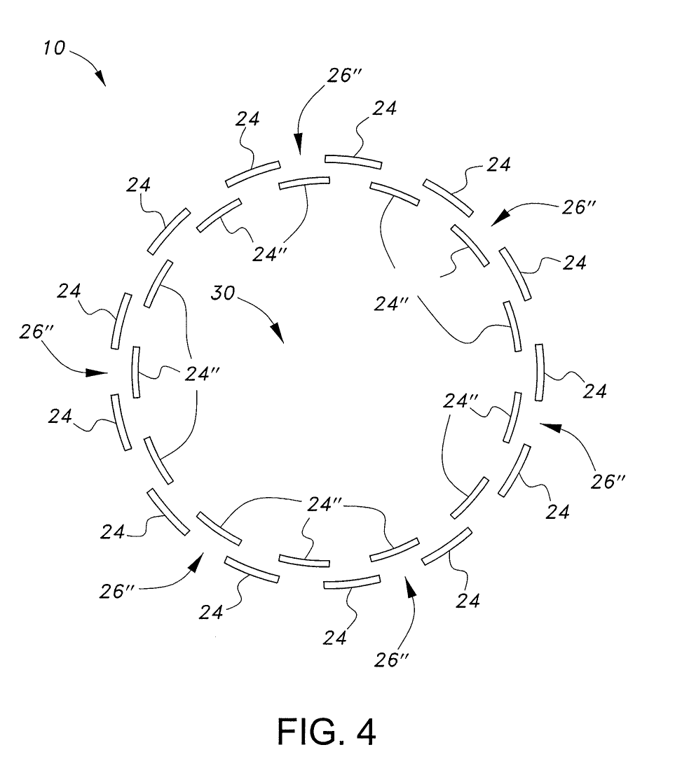

It should be understood that the substantially rectangular configuration of ribs 24 is shown in FIG. 2 for exemplary purposes only. The ribs 24 may have any desired cross-sectional configuration having rounded edges such that shear and turbulent flow are minimized. For example, the alternative embodiment of FIG. 3 shows ribs 24′ with a teardrop or airfoil-shaped cross-sectional configuration. Slots 26′ are formed between adjacent ones of ribs 24′. As a further alternative, FIG. 4 shows an embodiment similar to that of FIG. 1, but with a second, inner concentric body formed from ribs 24″. As shown, ribs 24″ are offset from ribs 24, thus creating slots or flow passages 26″, which pass not only between ribs 24, but between the outer body and the inner body, as well as between ribs 24″. In each embodiment, the slots or flow passages 26, 26″ are preferably between 0.2 mm and 3.2 mm. The length of each slot (i.e., the length of the sidewall of elongated body 12) is ultimately determined by the structural requirements of the device, but will typically be between approximately 5 mm and 3000 mm.

The elongated body 12 is formed from a flexible, heat-resistant and flame-resistant material, such as plastic, metal, nylon, high-density polyethylene (HDPE) or the like. While such materials will melt and burn when heated sufficiently, they provide sufficient durability for relatively short duration flare-ups that might occur from a relatively small quantity of fuel in a relatively small container.

The first end 20 has a toroidal configuration and serves as a mounting flange for installing the flame arrester 10 within a fuel container or its spout or neck. First end 20 is open to allow insertion of a fuel dispensing nozzle or the like. As shown in FIG. 1, the second end 22 is preferably open, and can be covered and sealed by a valve 14, which may be a check valve or the like. The valve 14 may be a spring-loaded check valve, such as that illustrated in the example of FIG. 1, pivotally secured at 16 to sidewall 18, although it should be understood that any suitable type of spring valve or the like may be used, such that valve 14 automatically closes after it is opened to receive fuel therethrough. The valve 14 will permit the insertion of a fuel nozzle therein, and then automatically close upon its removal. Alternatively, the valve 14 may be replaced by a closed, impervious disk or plug. As a further alternative, valve 14 may be replaced by an end or cover which is porous or which has slots formed therethrough, similar to slots or flow passages 26, 26′, 26″ described above.

The flame arrester 10 is adapted for permanent and immovable installation within a fuel container, such as a portable fuel can or a vehicle fuel tank. The flame arrester 10 may be installed within the body of the can or tank, or within the dispensing spout of the can or filler neck of the tank. Since any flame front that might develop in such relatively small containers and their short spouts or necks would be relatively weak and low pressure, the flame arrester 10 may be constructed of lighter, non-metallic materials, as opposed to flame arresters generally required for installation in gas pipelines and the like.

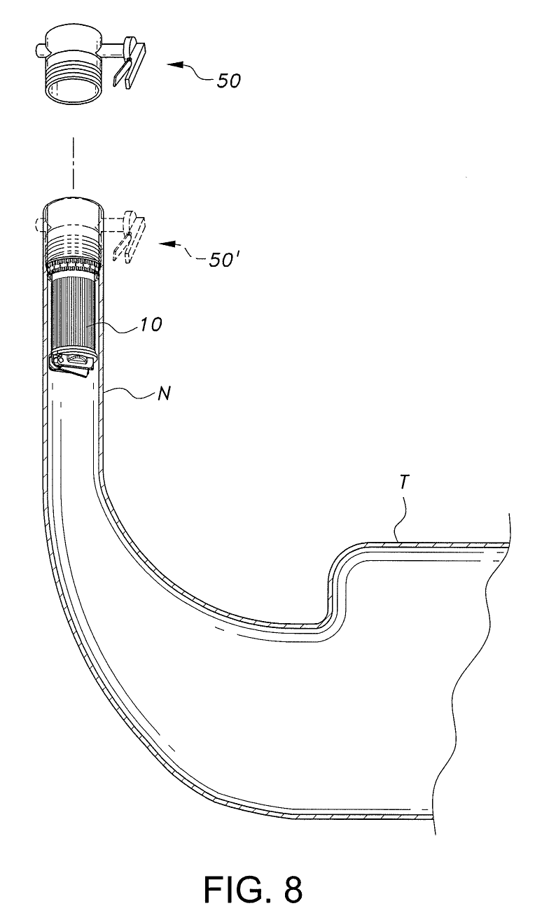

FIG. 8 shows the flame arrester 10 being inserted within the nozzle N of a conventional fuel tank T. It should be understood that nozzle N and fuel tank T are shown for exemplary purposes only. As shown, in addition to the flame arrester 10, a throttling valve 50 may be installed either on the fuel tank's nozzle N, as a cover, or alternatively may be installed within the fuel tank's nozzle N (as shown in phantom in FIG. 8 as throttling valve 50′). It should be understood that any suitable type of throttling valve may be used, such as a conventional butterfly valve, for example. Throttling valve 50 provides the user with control over the flow rate during dispensing of the fuel.

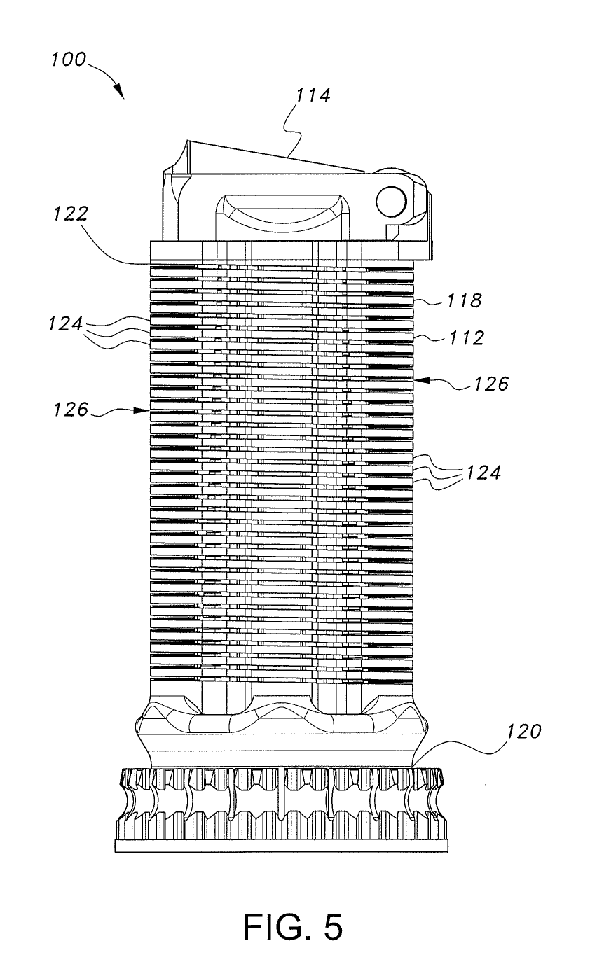

In the examples of FIGS. 1-4, flame arrester 10 had vertically-extending ribs 24, 24′, 24″ and corresponding vertically-extending slots 26, 26′, 26″. Here, the term “vertical” refers to the orientation shown in FIG. 1, i.e., along the direction of the axis of elongated body 12. FIG. 5 illustrates an alternative embodiment in which the ribs 124 are circumferential. Similar to the previous embodiments, the flame arrester 100 includes an elongated body 112 having at least one sidewall 118, a first end 120 and a second end 122. Sidewall 118 is formed from a plurality of ribs 124, which are substantially annular and arrayed circumferentially, spaced apart from one another such that adjacent ones of the ribs 124 define circumferential slots 126 therebetween. As in the previous embodiments, each rib 124 has rounded side edges in order to minimize shear and turbulent flow. The slots 126 are in open fluid communication with the hollow interior of elongated body 112, as in the previous embodiments. Further, similar to the previous embodiments, it should be understood that the second end 122 may be open and covered and sealed by a valve 114, or may be replaced by a closed, impervious disk or plug or, alternatively, replaced by an end or cover which is porous or which has slots formed therethrough.

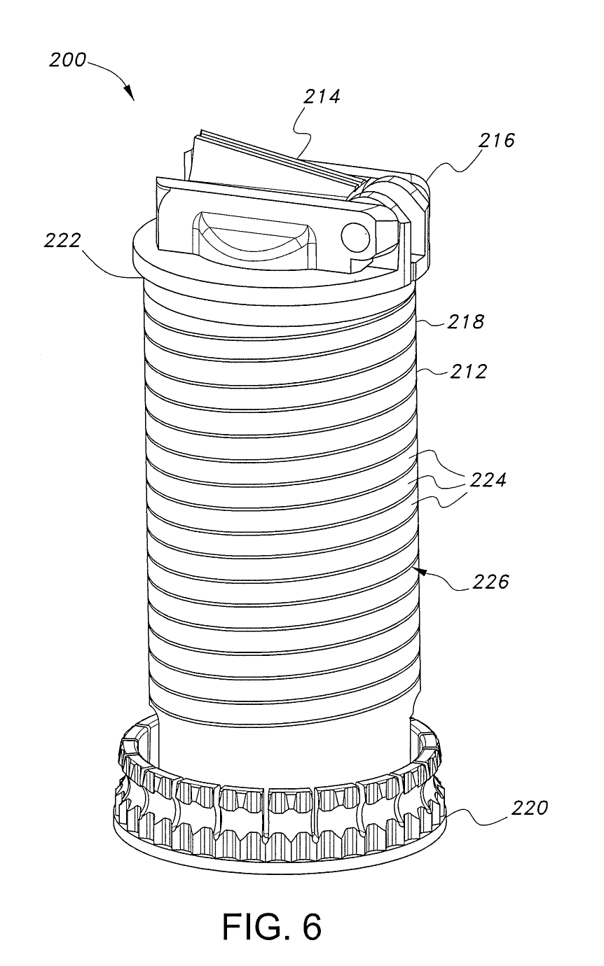

FIG. 6 illustrates another alternative embodiment. Flame arrester 200 includes an elongated body 212 having at least one sidewall 218, a first end 220 and a second end 222. Sidewall 218 is formed from a single rib 224, which is helical in configuration. Thus, a continuous, single helical slot 226 is correspondingly formed by helical rib 224. As in the previous embodiments, the rib 224 has rounded side edges in order to minimize shear and turbulent flow. The slot 226 is in open fluid communication with the hollow interior of the elongated body 212, as in the previous embodiments. Further, similar to the previous embodiments, it should be understood that the second end 222 may be open and covered and sealed by a valve 214, or may be replaced by a closed, impervious disk or plug or, alternatively, replaced by an end or cover which is porous or which has slots formed therethrough.

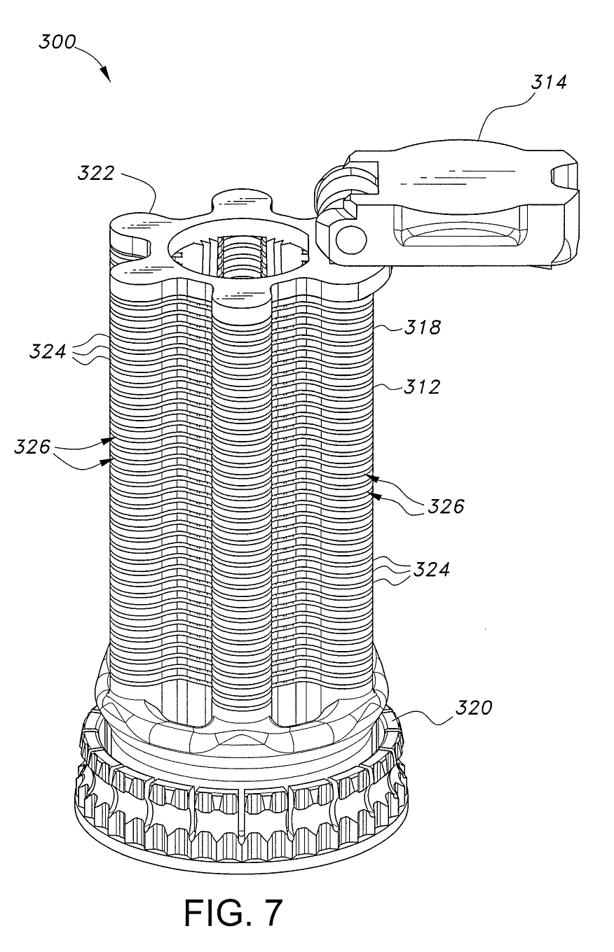

In the embodiments of FIG. 1-6, the elongated body is substantially cylindrical. It should be understood, however, that any suitable configuration may be used. For example, in the alternative flame arrester 300 of FIG. 7, the elongated body 312 has an undulating, multi-lobed cross-sectional configuration. As in the previous embodiments, the elongated body 312 includes at least one sidewall 318, a first end 320 and a second end 322. Similar to the embodiment of FIG. 5, the sidewall 318 is formed from a plurality of ribs 324, which are arrayed horizontally or circumferentially, and spaced apart from one another such that adjacent ones of the ribs 324 define horizontal or circumferential slots 326 therebetween. As in the previous embodiments, each rib 324 has rounded side edges in order to minimize shear and turbulent flow. The slots 326 are in open fluid communication with the hollow interior of the elongated body 312, as in the previous embodiments. Further, similar to the previous embodiments, it should be understood that the second end 322 may be open and covered and sealed by a valve 314, or may be replaced by a closed, impervious disk or plug or, alternatively, replaced by an end or cover which is porous or which has slots formed therethrough.

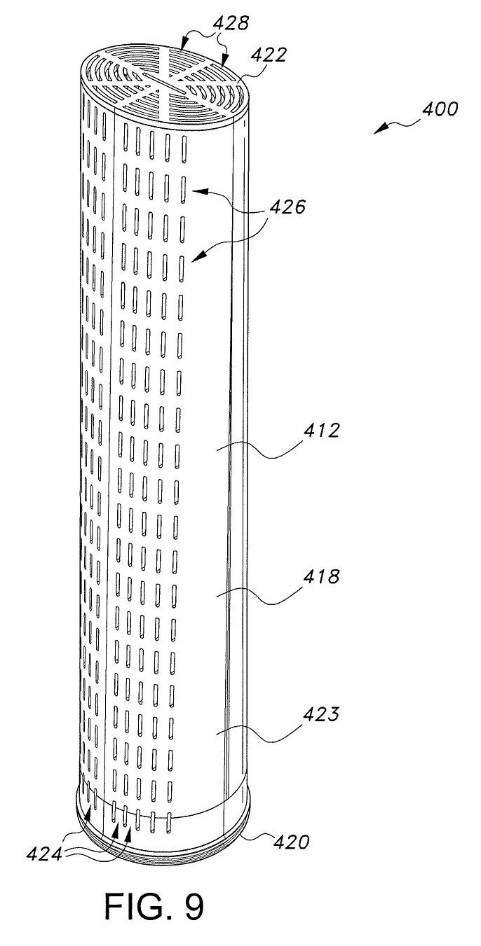

In the alternative embodiment of FIG. 9, flame arrester 400 includes an elongated body 412 having at least one sidewall 418, defining an open interior, and axially-opposed first and second ends 420, 422, respectively. In the embodiment of FIG. 1, the at least one sidewall 18 is defined by a continuous array of spaced apart ribs 24, whereas in the embodiment of FIG. 9, the at least one sidewall 18 includes both a solid portion 423 (i.e., a portion which is continuous and uninterrupted by slots), and a portion defined by ribs or axially-extending structural portions 424. The ribs or axially-extending structural portions 424 extend between an axially-extending array of slots 426. As in the previous embodiments, each of the ribs or axially-extending structural portions 424 has a rounded side edge, with the slots 426 being in open fluid communication with the hollow interior of the elongated body 412. As noted above, the valves of the flame arresters described above may be replaced by a closed, impervious disk or plug or, alternatively, replaced by an end or cover which is porous or which has slots formed therethrough. In FIG. 9, second end 422 includes a cover having slots 428 formed therethrough. The cover can be flat, as shown.

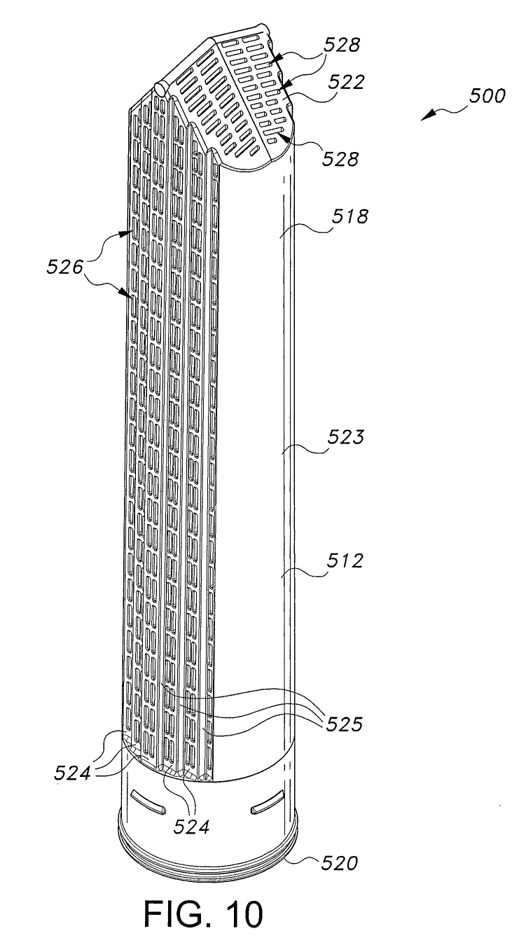

In the further alternative embodiment of FIG. 10, flame arrester 500 includes an elongated body 512 having at least one sidewall 518, defining an open interior, and axially-opposed first and second ends 520, 522, respectively. Similar to the embodiment of FIG. 9, the at least one sidewall 518 of the embodiment of FIG. 10 includes both a solid portion 523 (i.e., a portion which is continuous and uninterrupted by slots), and a portion defined by axially-extending structural portions 524. As shown in FIG. 10, at least some of the axially-extending structural portions 524 may be arrayed in a stepped configuration. Each of the stepped portions 524 includes two or more ribs 525, defining at least one axially-extending array of slots 526 formed therebetween. As in the previous embodiments, each of the ribs 525 has a rounded side edge, with the slots 526 being in open fluid communication with the hollow interior of the elongated body 512. As noted above, the valves of the flame arresters described above may be replaced by a closed, impervious disk or plug or, alternatively, replaced by an end or cover which is porous or which has slots formed therethrough. In FIG. 10, second end 522 defines a cover having slots 528 formed therethrough. The cover can be angled or sloped to include at least two sides or surfaces with slots 528 formed therethrough, as shown.

It is to be understood that the flame arrester is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

I claim:

1. A flame arrester, comprising an elongated body having at least one sidewall defining an open interior and axially-opposed first and second ends, the at least one sidewall includes a plurality of ribs spaced apart from one another such that adjacent ones of the ribs define at least one slot therebetween, each of the ribs having a rounded side edge, the slots being in open fluid communication with the hollow interior of the elongated body.

2. The flame arrester as recited in claim 1, wherein the first end and the second end of said elongated body are each open.

3. The flame arrester as recited in claim 2, further comprising a valve mounted on the second end of said elongated body for releasably covering and sealing the second end.

4. The flame arrester as recited in claim 1, wherein said sidewall is defined by said plurality of ribs and one slot is defined between each pair of adjacent ribs, said slot extending along a length of said ribs.

5. The flame arrester as recited in claim 1, wherein said sidewall is defined by a first solid portion and a second ribbed portion, the second ribbed portion including the plurality of ribs, a plurality of spaced slots defined between each pair of adjacent ribs.

6. The flame arrester as recited in claim 1, further comprising an inner wall positioned within the at least one sidewall and being concentric therewith, the inner wall being radially spaced apart from the at least one sidewall, the inner wall being defined by a plurality of inner ribs spaced apart from one another such that adjacent ones of the inner ribs define inner slots therebetween, each of the inner ribs having a rounded side edge.

7. The flame arrester as recited in claim 6, wherein each said rib and each said inner rib extends axially between the axially-opposed first and second ends.

8. The flame arrester as recited in claim 1, wherein each said rib is substantially annular and adjacent ones of the ribs are axially spaced apart from one another.

9. The flame arrester as recited in claim 1, wherein adjacent ones of the ribs are spaced apart from one another by approximately 0.2 mm to approximately 3.2 mm.

10. A flame arrester, comprising an elongated body having at least one sidewall defining an open interior and axially-opposed first and second ends, the at least one sidewall being defined by a helical rib, wherein circumferential segments of the helical rib are spaced apart from one another such that adjacent ones of the circumferential segments define a helical slot therebetween, the helical rib having a rounded side edge, the helical slot being in open fluid communication with the hollow interior of the elongated body.

11. The flame arrester as recited in claim 10, wherein the first end and the second end of said elongated body are each open.

12. The flame arrester as recited in claim 11, further comprising a valve mounted on the second end of said elongated body for releasably covering and sealing the second end.

13. The flame arrester as recited in claim 10, wherein adjacent ones of the circumferential segments are spaced apart from one another between approximately 0.2 mm to approximately 3.2 mm

14. A fuel tank with a flame arrester, comprising:
a fuel tank having a nozzle;
a flame arrester adapted for mounting within the nozzle of the fuel tank, the flame arrester having an elongated body with at least one sidewall defining an open interior and axially-opposed first and second ends, the at least one sidewall including a plurality of ribs spaced apart from one another such that adjacent ones of the ribs define at least one slot therebetween, each of the ribs having a rounded side edge, the slots being in open fluid communication with the hollow interior of the elongated body; and
a throttling valve mounted to the nozzle.

15. The fuel tank with a flame arrester as recited in claim 14, wherein the first end and the second end of said elongated body of the flame arrester are each open.

16. The fuel tank with a flame arrester as recited in claim 15, further comprising a valve mounted on the second end of said elongated body of the flame arrester for releasably covering and sealing the second end.

17. The fuel tank with a flame arrester as recited in claim 14, wherein said sidewall is defined by said plurality of ribs and one slot is defined between each pair of adjacent ribs, said slot extending along a length of said ribs.

18. The flame arrester as recited in claim 14, wherein said sidewall is defined by a first solid portion and a second ribbed portion, the second ribbed portion including the plurality of ribs, a plurality of spaced slots defined between each pair of adjacent ribs.

19. The fuel tank with a flame arrester as recited in claim 14, wherein the flame arrester further comprises an inner wall positioned within the at least one sidewall and being concentric therewith, the inner wall being radially spaced apart from the at least one sidewall, the inner wall being defined by a plurality of inner ribs spaced apart from one another such that adjacent ones of the inner ribs define inner slots therebetween, each of the inner ribs having a rounded side edge.

20. The fuel tank with a flame arrester as recited in claim 14, wherein each said rib of the flame arrester is substantially annular and adjacent ones of the ribs are axially spaced apart from one another.
